(19) United States
(12) Patent Application Publication
(10) Pub. No.: US 2016/0021923 A1
(43) Pub. Date: Jan. 28, 2016

(54) High-Protein Gelled Food Products Made Using High-Protein Microalgae

(71) Applicant: Solazyme, Inc., South San Francisco, CA (US)

(72) Inventors: Starla Paulsen, Twin Falls, ID (US); Beata Klamczynska, Orinda, CA (US); Ken Plasse, San Carlos, CA (US); Charles Bowman, Reidsville, NC (US)

(21) Appl. No.: 14/808,175

(22) Filed: Jul. 24, 2015

Related U.S. Application Data
(60) Provisional application No. 62/028,479, filed on Jul. 24, 2014.

(51) Int. Cl. A23L 1/337; A23L 1/0562; A23L 1/0524

(52) U.S. Cl. CPC A23L 1/337; A23L 1/0524; A23L 1/05625; A23V 2002/00

(57) ABSTRACT

A gelatinous or “gummy” confection is supplemented with low-DHA, low-chlorophyll, high-protein microalgal cells. Because the microalgal cell walls encapsulate the microalgal protein, the microalgal cells do not interfere with the setting process of the confection. The confection can be produced by combining gelatin or other gelling agent with sweetener, color, flavor, and intact high-protein microalgae. The microalgae can be obtained from heterotrophic cultivation of Chlorella protothecoides or other microalgal cells under nitrogen replete conditions with washing, pasteurization and drying to obtain microalgal flour with at least 50% microalgal protein by weight.

### CROSS REFERENCE TO RELATED APPLICATIONS

This application claims the benefit under 35 U.S.C. 119(e) of U.S. Provisional Patent Application No. 62/028,479, filed Jul. 24, 2014, which is incorporated herein by reference in its entirety.

### TECHNICAL FIELD

The present invention relates to increasing the amount of protein in gelatinous foods.

### BACKGROUND

As the human population continues to increase, there is a growing need for additional food sources, particularly food sources that are inexpensive to produce and nutritious. Moreover, the current reliance on meat as the staple of many diets, at least in the most developed countries, contributes significantly to the release of greenhouse gases. There is a need for new foodstuffs that are less harmful to the environment to produce.

Requiring only water and sunlight to grow, algae have long been looked to as a potential source of food. While certain types of algae, primarily seaweed, do indeed provide important foodstuffs for human consumption, the promise of algae as a foodstuff has not been fully realized. Algal powders made with algae grown photosynthetically in outdoor ponds or photobioreactors are commercially available but have a deep green color (from the chlorophyll) and a strong, unpleasant taste. When formulated into food products or as nutritional supplements, these algal powders impart a visually unappealing green color to the food product or nutritional supplement and have unpleasant fish, seaweed or other flavors.

There are several species of algae that are used in foodstuffs today, most being macroalgae such as kelp, purple layer (Porphyra, used in nori), dulse (Palmaria palmate) and sea lettuce (Ulva lactuca). Microalgae, such as Spirulina (Arthrospira platensis) are grown commercially in open ponds (photosynthetically) for use as a nutritional supplement or incorporated in small amounts in smoothies or juice drinks (usually less than 0.5% w/w). Other microalgae, including some species of Chlorella are popular in Asian countries as a nutritional supplement.

Poor flavor is a major factor that has impeded the widespread adoption of microalgae in food. WO2010/045368, WO2010/120923, PCT/US13/65369, and PCT/US14/013,405 disclose methods of making and using microalgal biomass as a food. These references disclose the growth of microalgae, especially Chlorella protothecoides, in a dark environment, to produce a non-green microalgal biomass.

Many people do not consume enough protein. Lack of protein can cause a variety of health problems, including growth failure, loss of muscle mass, decreased immunity, and weakening of the heart and respiratory system. A diet of protein-rich foods can help maintain good health. However, protein content is not the only consideration in a high-protein diet; many foods that are high in protein also contain elements that are harmful when consumed in excess, such as saturated fats and sodium.

Protein supplements help meet dietary protein requirements by providing a source of protein without the potentially harmful additional elements. However, protein supplements are typically in a powder form and must be mixed with a liquid before consumption. There is a need for a protein supplement in a form that is convenient, self-contained, or easier to handle or consume.

Gelatinous foods such as “gummy” confections have long been supplemented with vitamins as a vehicle for supplemental vitamins and other nutrients such as minerals for children and adults. These gummy vitamins are often flavored and are a convenient form for delivering supplemental vitamins and nutrients. Unlike vitamins, however, the addition of protein to gelatinous foods often results in alteration of the gel structure and/or a negative effect on the sensory properties of the food. Due to their convenience, gummy confections that contain proteins and/or amino acids are an improved means of delivering protein to the consumer. Thus, alternate and improved methods for supplementing gelatinous foods with protein are needed.

### SUMMARY

In one aspect, the present invention provides a method for making a high-protein gelled food product. The method includes combining a gel-forming material, water, and a high protein microalgal flour, and optionally sweetener, flavor or color, dissolving the gel forming material (optionally gelatin and/or pectin), and setting and shaping the material so as to form the gelled food product.

The resulting gelled food product can have at least 0.25, 0.5, 0.75, 1, 2 or 4 grams of microalgal protein per 30 gram serving. The microalgal flour can have at least 20%, 30%, 40%. 50% or 60% microalgal protein by dry cell weight, less than 200 ppm of chlorophyll and less than 5% DHA. The high protein microalgal flour can be predominantly of intact microalgal cell bodies or lysed microalgal cell bodies of heterotrophically cultivated microalgae.

The food product can comprise at least 0.5, 1, 2, 3, 4, 5, 10, 20, 30, 40, or 50% protein by weight.

The microalgal flour can be produced from dried Chlorella, can be non-green in color, yellow, or yellow-white in color. Optionally, the Chlorella is white or yellow-white in color and is a color-mutant. The species of Chlorella can be Chlorella protothecoides. Alternately, the microalgae can be of the genus Prototheca and optionally Prototheca moriformis

The microalgal flour can have cells with, on average, less than 30%, 25%, 20%, 15%, or 14% lipid or cells with, on average, 5-30, 5-20, 7-14, 8-13, or 10-13% lipid.

In accordance with an embodiment, a gelled food product results from one or more of the above methods. In various embodiments, the resulting gelled food product comprises any one or more of the features discussed above or herein.

In one aspect, the present invention provides a gelled food product produced by the process of: (a) combining a gel-forming material, water, and a high protein microalgal flour, and optionally sweetener, flavor or color; (b) dissolving the gel forming material, optionally gelatin and/or pectin; and (c) setting and shaping the material so as to form the gelled food product.

In some cases, the gelled food product comprises at least 0.25, 0.5, 0.75, 1, 2 or 4 grams of microalgal protein per 30 gram serving. In some cases, the gelled food product comprises at least 2%, 3%, 4%, 5%, 6%, 7%, 8%, 9%, 10% 12%, 14%, 15%, 17% or 20% by weight microalgal flour. In some cases, the gelled food product comprises at least 0.5, 1, 2, 3, 4, 5, 10, 20, 30, 40, or 50% protein (e.g., w/w).

In some embodiments of the gelled food product, the high protein microalgal flour is comprised predominantly of intact microalgal cell bodies of heterotrophically cultivated microalgae. In some cases, the microalgal flour comprises Chlorella. In some cases, the Chlorella is of the species Chlorella protothecoides. In various embodiments, the gelled food product can comprise at least 2%, 3%, 4%, 5%, 6%, 7%, 8%, 9%, 10% 12%. 14%, 15%, 17% or 20% by weight microalgal flour.

In some embodiments, the gelled food product further comprises vitamins and nutrients.

### BRIEF DESCRIPTION OF THE DRAWINGS

FIG. 1 shows a flow diagram depicting a method for producing a gelatinous food product.

FIG. 2 shows measurements of the viscosity of acidic solutions of high protein microalgae, whey and soy protein (respectively, from left to right at each time point) after heating at 70° C. for varying amounts of time.

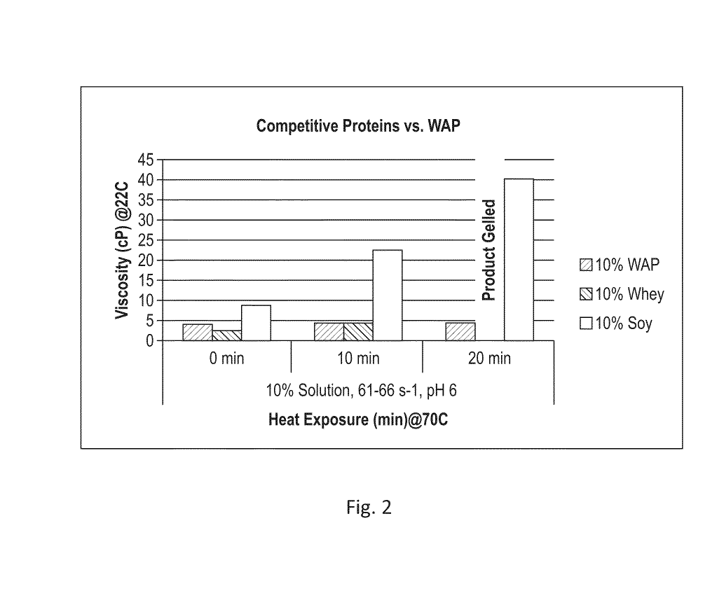

### DETAILED DESCRIPTION

### Definitions

Unless defined otherwise, all technical and scientific terms used herein have the meaning commonly understood by a person skilled in the art to which this invention belongs. As used herein, the following terms have the meanings ascribed to them unless specified otherwise.

“Between” as used herein shall be inclusive of the endpoints.

“Dry weight” or “dry cell weight” refer to weight as determined in the relative absence of water. For example, reference to a component of microalgal biomass as comprising a specified percentage by dry weight means that the percentage is calculated based on the weight of the biomass after all or substantially all water has been removed.

“Exogenous gene” refers to a nucleic acid transformed into a cell. A transformed cell may be referred to as a recombinant cell, into which additional exogenous gene(s) may be introduced. The exogenous gene may be from a different species (and so heterologous), or from the same species (and so homologous) relative to the cell being transformed. In the case of a homologous gene, it occupies a different location in the genome of the cell relative to the endogenous copy of the gene. The exogenous gene may be present in more than one copy in the cell. The exogenous gene may be maintained in a cell as an insertion into the genome or as an episomal molecule.

“Exogenously provided” describes a molecule provided to the culture media of a cell culture.

“Fixed carbon source” means molecule(s) containing carbon, preferably organic, that are present at ambient temperature and pressure in solid or liquid form.

“Fatty acid profile” refers to the distribution of different carbon chain lengths and saturation levels of fatty acid moieties in a particular sample of biomass or oil. “Triglycerides” are lipids where three fatty acid moieties are attached to a glycerol moiety. A sample could contain lipids in which approximately 60% of the fatty acid moieties is C 18:1, 20% is C 18:0, 15% is C 16:0, and 5% is C 14:0. In cases in which a carbon length is referenced generically, such as “C 18,” such reference can include any amount of saturation; for example, microalgal biomass that contains 20% lipid as C 18 can include C18:0, C 18:1, C 18:2, and the like, in equal or varying amounts, the sum of which constitute 20% of the biomass.

“Good Manufacturing Practices” (GMP) refers to the regulations promulgated by the US Food and Drug Administration under the authority of the Food, Drug, and Cosmetics Act that require manufacturers to take precautions to insure that their products are safe, pure and effective. Chapter 9 subchapter IV of the FDCA (21 U.S.C. §342) covers regulations related to food, or similar legislation as promulgated by other countries of the world.

“High-protein” means that the gelled product has at least 0.25 grams of microalgal protein per 30 gram serving.

“Homogenate” or “lysed” means biomass that has been physically disrupted.

“Homogenize” means to blend two or more substances into a homogenous or uniform mixture. In some embodiments, a homogenate is created. In other embodiments, the biomass is predominantly intact, but homogenously distributed throughout the mixture.

“Predominantly intact” cells refers to a population of cells that comprise more than 50%, 75%, or 90% intact cells. “Intact” refers to the physical continuity of the cellular membrane enclosing the intracellular components of the cell and means that the cellular membrane has not been disrupted in any manner that would release the intracellular components of the cell to an extent that exceeds the permeability of the cellular membrane under conventional culture conditions or those culture conditions described herein. “Intact” in connection with microalgal cells of a microalgal flour shall mean that the cells have not been treated with a disruption technique such as bead-milling designed to expose and release intracellular components. As a result, the cell walls of the microalgal cells are essentially continuous so as to contain the intracellular proteins.

“Predominantly lysed” cells means a population of cells in which more than 50%, and typically more than 75 to 90%, of the cells have been disrupted such that the intracellular components of the cell are no longer completely enclosed within the cell membrane. “Lysed” in connection with microalgal cells of a microalgal flour shall mean that the cells have been treated with a disruption technique such as bead-milling designed to expose and release intracellular components.

“Lipids” are a class of molecules that are soluble in nonpolar solvents (such as ether and hexane) and are relatively or completely insoluble in water. Lipid molecules have these properties because they consist largely of long hydrocarbon tails that are hydrophobic in nature. Examples of lipids include fatty acids (saturated and unsaturated); glycerides or glycerolipids (such as monoglycerides, diglycerides, triglycerides or neutral fats, and phosphoglycerides or glycerophospholipids); nonglycerides (sphingolipids, tocopherols, tocotrienols, sterol lipids including cholesterol and steroid hormones, prenol lipids including terpenoids, fatty alcohols, waxes, and polyketides); and complex lipid derivatives (sugar-linked lipids, or glycolipids, and protein-linked lipids).

“Microalgae” refers to eukaryotic microbial organisms that contain a chloroplast or other plastid, and optionally that are capable of performing photosynthesis, or a prokaryotic microbial organism capable of performing photosynthesis. Microalgae include obligate photoautotrophs, which cannot metabolize a fixed carbon source as energy, as well as heterotrophs, which can live solely off a fixed carbon source. Microalgae include unicellular organisms that separate from sister cells shortly after cell division, such as Chlamydomonas, as well as microbes such as, for example, Volvox, which is a simple multicellular photosynthetic microbe of two distinct cell types. Microalgae include cells such as Chlorella, Dunaliella, and Prototheca. Microalgae also include other microbial photosynthetic organisms that exhibit cell-cell adhesion, such as Agmenellum, Anabaena, and Pyrobotrys. Microalgae also include obligate heterotrophic microorganisms that have lost the ability to perform photosynthesis. Examples of obligate heterotrophs include certain dinoflagellate algae species and species of the genus Prototheca. Microalgae include those belonging to the phylum Chlorophyta and in the class Trebouxiophyceae. Within this class are included microalgae belonging to the order Chlorellales, optionally the family Chlorellaceae, and optionally the genus Prototheca, Auxenochlorella, Chlorella, Parachlorella, Schizochytrids, Thraustochytrids, or Aurantiochytrids.

“Microalgal biomass,” “algal biomass” or “biomass” refers to material produced by growth and/or propagation of microalgal cells. Biomass may contain cells and/or intracellular contents as well as extracellular material. Extracellular material includes, but is not limited to, compounds secreted by a cell.

“Microalgal extracts” refer to any cellular components that are extracted from the cell or are secreted by the cells. The extracts include those that can be obtained by mechanical pressing of the cells or by solvent extraction. Cellular components can include, but are not limited to, microalgal oil, proteins, carbohydrates, phospholipids, polysaccharides, macromolecules, minerals, cell wall, trace elements, carotenoids, and sterols. In some cases the extract is a polysaccharide that is secreted from a cell into the extracellular environment and has lost any physical association with the cells. In other cases the polysaccharide remains associated with the cell wall. Polysaccharides are typically polymers of monosaccharide units and have high molecular weights, usually with an average of 2 million Daltons or greater, although fragments can be smaller in size.

“Modified microalgal extracts” refer to extracts that are chemically or enzymatically modified. For example, triglyceride extracts can be converted to fatty acid alkyl esters (e.g. fatty acid methyl esters) by transesterification.

The terms “microalgal powder” and “microalgal flour” are used interchangeably and mean a particulate dried cultured microalgae cell product with particles suitably sized for effective dispersion in a liquid.

“Nutrient” means vitamins, minerals such as boron, cobalt, chromium, calcium, copper, fluride, iodine, iron, magnesium, manganese, molybdenum, sodium, potassium, selenium and zinc, organic acids such as acetic acid, citric acid, lactic acid, malic acid, choline and taurine, phytochemicals such as sterols, luteins, lycopenes and other compounds consumed by humans for nutritional purposes.

Reference to proportions by volume, i.e., “v/v,” means the ratio of the volume of one substance or composition to the volume of a second substance or composition. For example, reference to a composition that comprises 5% v/v microalgal flour and at least one other food ingredient means that 5% of the composition's volume is composed of microalgal flour; e.g., a composition having a volume of 100 mm³ would contain 5 mm³ of microalgal flour and 95 mm³ of other constituents.

Reference to proportions by weight, i.e., “w/w,” means the ratio of the weight of one substance or composition to the weight of a second substance or composition. For example, reference to a food composition that comprises 5% w/w microalgal flour and at least one other food ingredient means that 5% of the food composition is composed of the microalgal flour; e.g., a 100 mg food composition would contain 5 mg of microalgal flour and 95 mg of other constituents.

The present invention is based on the discovery that gelatinous food products can be supplemented with protein in the form of microalgal flour while retaining the gel structure of the product and maintaining positive organoleptic properties.

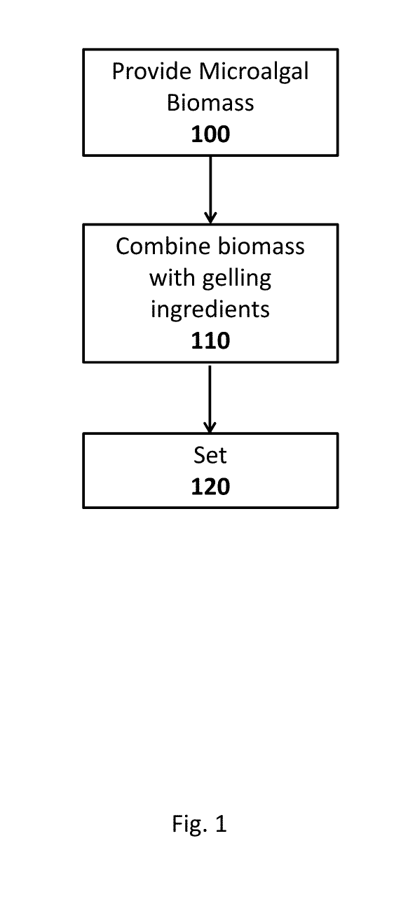

FIG. 1 illustrates a method for producing a gelatinous food product, in accordance with embodiments of the invention. A microalgal biomass is provided (step 100). The biomass can be produced according to the methods described in WO2010/045368, WO2010/120923, PCT/US13/65369 and/or PCT/US14/013,405. The biomass is high in protein and has predominantly intact cells. For example, the biomass can comprise at least 30, 35, 40, 45, 50, 55, 60, or 65% protein by dry cell weight and be comprised of at least 60, 70, 80, 90, or 95% intact (unlysed) microalgal cells. The microalgal biomass can be in the form of a powder or flour in order to facilitate dispersion in the food product. As described in the above references, the microalgal cells can be produced by heterotrophic cultivation with washing, pasteurization and spray drying. In various embodiments, the microalga is a eukaryotic microalga of the taxonomy: Chlorophyta, Trebouxiophyceae, Chlorellales, Chlorellaceae, or Chlorophyceae. The microalgal species used to produce the powder can be chosen to produce a non-green biomass without the use of bleaching. Such species include non-green Chlorella such as Chlorella protothecoides or a non-green color-mutant of a green Chlorella or other microalgae. The color-mutants can produce a flour that is white, tan, or light yellow. See WO2010/045368 and WO2010/120923. Alternately, the microalgal species can be a non-green, obligately heterotrophic, microalga such as a species of the genus Prototheca such as Prototheca stagnorum, P. moriformis, P. kruegeri, P. cutis, P. zopfii, P. ulmea, P. wickerhamii, or P. blaschkeae. To avoid a fishy taste, the microalga can produce long chain polyunsaturates such as DHA at very low levels. For example, DHA can be less than 5, 3, 2, 1, 0.5 or 0.1% of the microalga and biomass. This is true of the Chlorella and Prototheca genera for example. In specific embodiments, the cells of the microalgal flour can comprise, on average, 5-30, 5-20, 7-14, 8-13, or 10-13, or 13-20% lipid. Percentage protein is determined by the Dumas method applying an adjustment factor of 6.25.

As a result of the microalgal protein supplementation, the food product will comprise at least 0.1, 0.5, 1, 2, 3, 4, 5, 6, 7, 8, 9, 10, 11, 12, 13, 14, 15, 20, 25, or 30% microalgal protein from the microalgal flour. For example, the food product can comprise 1-5, 5-10, 10-15, or 15-20% microalgal protein.

Because the microalgal cells are intact, the intracellular proteins will be protected from aggregating with the other proteins of present in the gelled food product, even after harsh pathogen inactivation steps. The cell walls will render the cells as a whole stably dispersible in the liquid. The cells can be intact such that at least 70, 75, 80, 85, 90, or 95% of the intracellular proteins remain within the cell at various stages of the process including in the completed food product.

Alternatively, when the microalgal cells are lysed, the cells will not be lysed to 100%. The lysed cells because they contain not just the microalgal proteins but all of the other cellular components as well as the protein, the microalgal proteins will be inhibited from aggregating with the other proteins present in the gelled food product.

The microalgal biomass can be combined with other ingredients to form a gelled product (step 110). For example, the biomass can be combined with water and gelatin and/or pectin. Optionally, the gelled product can be sweetened with sucrose, glucose, fructose, corn syrup, high-fructose corn syrup, other natural or artificial sweetener or a combination of these. Optionally, preservatives, coloring, or flavoring is added.

The mixture from step 110 is then set (step 120). For example, the mixture can be heated to dissolve all the ingredients and cooled. The material can be cast in a mold, extruded, or otherwise shaped.

In this way, a gelatin, gummy confection or other gelled food can be produced. The food can be directly packaged for distribution or used as an ingredient in another food product.

In a specific embodiment, a dried microalgal flour is produced by culturing Chlorella protothecoides heterotrophically in a dark environment, washing, pasteurizing and drying so as to have at least 50% protein by dry cell weight, less than 200 ppm of chlorophyll and less than 5% DHA. The cells of the flour are intact such that at least 70% of the intracellular protein remains within the cells of the flour. The flour is combined with gelatin or pectin, water, sweetener, flavor and color, heated, shaped and cooled. The resulting gummy confection is not green (unless green food color is added) and has at least 0.2%, 0.5%, 0.75%, 1%, 2%, 5% or 10% microalgal protein by weight. Optionally, the confection has at least 0.25, 0.5, 0.75, 1, 2, or 4 grams of microalgal protein from the microalgal flour per 30 gram serving.

In another embodiment, the gelled food product comprises at least 2%, 3%, 4%, 5%, 6%, 7%, 8%, 9%, 10% 12%. 14%, 15%, 17% or 20% by weight microalgal flour. The desired amount of the microalgal flour is present in the gelled food product to provide the desired amount of microalgal protein in the gelled food product.

### EXAMPLES

### Example 1

### Production of a Microalgal Gummy Confection

A gummy confection was made by combining and heating the ingredients of Table 1 in the specified proportion. The mixture was heated to a temperature of 226-240° F., poured into troll-shaped starch molds and cooled to set. The resulting gummy has 4 grams of protein per 30 gram serving, of which 2 grams was from the microalgal flour. This experiment demonstrated that the high-protein microalgal flour did not interfere with the cooking and setting of the gummy. The gummy had favorable taste and smell (i.e., these properties were not impacted by the added protein).

TABLE 1
Ingredients of microalgal gummy confection.

| Ingredient | % by weight |
|---|---|
| Gelatin | 8.4 |
| Water | 19.3 |
| Sugar (sucrose) | 24.8 |
| Microalgal flour (C. protothecoides, | 10.7 |
| unlysed, 65% protein) | |
| Corn syrup (42 DE) | 33.2 |
| Citric acid (50% solution) | 3.2 |
| Flavor | 0.3 |
| Color | 0.1 |

### Example 2

### Production of a Vegan Microalgal Gummy Confection

A gummy troll confection was made by combining and heating the ingredients of Table 2 in the specified proportion. The mixture was adjusted to a pH of 3.3 with a target Brix of 80, poured into starch molds and cooled to set. The resulting gummy troll has 2 grams of protein per 30 gram serving, of which all of the protein was from the microalgal flour. This experiment demonstrated that the high-protein microalgal flour did not interfere with the cooking and setting of the gummy. The gummy had favorable taste and smell (i.e., these properties were not impacted by the added protein).

TABLE 2
Ingredients of vegan microalgal gummy confection.

| Ingredient | % by weight |
|---|---|
| Com syrup (42DE) | 29.1 |
| Microalgal flour (C. protothecoides, | 10.3 |
| 65% protein) | |
| Pectin solution (1.9%) | 26.0 |
| Sucrose | 24.1 |
| Water | 7.4 |
| Citric acid | 1.9 |
| Sodium Citrate | 0.4 |
| Flavor | 0.6 |
| Color | 0.2 |

Although the above discussion discloses various exemplary embodiments of the invention, it should be apparent that those skilled in the art can make various modifications that will achieve some of the advantages of the invention without departing from the true scope of the invention.

1. A method for making a high-protein gelled food product comprising:
(a) combining a gel-forming material, water, and a high protein microalgal flour, and optionally sweetener, flavor or color;
(b) dissolving the gel forming material, optionally gelatin and/or pectin; and
(c) setting and shaping the material so as to form the gelled food product.

2. The method of claim 1, wherein the gelled food product comprises at least 0.25, 0.5, 0.75, 1, 2 or 4 grams of microalgal protein per 30 gram serving.

3. The method of claim 1, wherein the microalgal flour comprises at least 50% microalgal protein by dry cell weight, less than 200 ppm of chlorophyll and less than 5% DHA.

4. The method of claim 1, wherein the high protein microalgal flour is comprised predominantly of intact microalgal cell bodies of heterotrophically cultivated microalgae.

5. The method of claim 1, wherein the food product comprises at least 0.5, 1, 2, 3, 4, 5, 10, 20, 30, 40, or 50% protein.

6. The method of claim 1, wherein the microalgal flour comprises Chlorella.

7. The method of claim 6, wherein the flour is not green in color.

8. The method of claim 6, wherein the Chlorella is yellow, white or yellow-white in color.

9. The method of claim 6, wherein the Chlorella is a color-mutant.

10. The method of claim 6, wherein the Chlorella is of the species Chlorella protothecoides.

11. The method of claim 1, wherein the microalgal flour comprises dried Prototheca.

12. The method of claim 1, wherein the microalgal flour has cells with, on average, less than 20%, 15%, or 14% lipid.

13. The method of claim 1, wherein the microalgal flour has cells with, on average, 5-20, 7-14, 8-13, or 10-13% lipid.

14. A gelled food product produced by the process of:
(a) combining a gel-forming material, water, and a high protein microalgal flour, and optionally sweetener, flavor or color;
(b) dissolving the gel forming material, optionally gelatin and/or pectin; and
(c) setting and shaping the material so as to form the gelled food product.

15. The gelled food product of claim 14, wherein the gelled food product comprises at least 0.25, 0.5, 0.75, 1, 2 or 4 grams of microalgal protein per 30 gram serving.

16. The gelled food product of claim 14, wherein
the gelled food product comprises at least 2%, 3%, 4%, 5%, 6%, 7%, 8%, 9%, 10% 12%, 14%, 15%, 17% or 20% by weight microalgal flour.

17. The gelled food product of claim 14, wherein the high protein microalgal flour is comprised predominantly of intact microalgal cell bodies of heterotrophically cultivated microalgae.

18. The gelled food product of claim 14, wherein the gelled food product comprises at least 0.5, 1, 2, 3, 4, 5, 10, 20, 30, 40, or 50% protein w/w.

19. The gelled food product of claim 14, wherein the microalgal flour comprises Chlorella.

20. The gelled food product of claim 20, wherein the Chlorella is of the species Chlorella protothecoides.

21. The gelled food product of claim 14 further comprising vitamins and nutrients.
